(19) United States
(12) Patent Application Publication
(10) Pub. No.: US 2025/0183829 A1
(43) Pub. Date: Jun. 5, 2025

(54) OPTIMIZED SETPOINT CURRENT PRESET FOR AN EXTERNALLY EXCITED SYNCHRONOUS MOTOR

(71) Applicant: Primetals Technologies Germany GmbH, Erlangen (DE)

(72) Inventors: Knut GRAICHEN, Heroldsberg (DE); Klaus LOEHE, Fürth (DE); Johannes REINHARD, Heiligenstadt (DE)

(21) Appl. No.: 18/729,128

(22) PCT Filed: Dec. 13, 2022
(86) PCT No.: PCT/EP2022/085543

§ 371 Date: Jul. 15, 2024

(30) Foreign Application Priority Data
Jan. 17, 2022 (EP) 22151805.3

(51) Int. Cl. H02P 21/22; H02P 21/18; H02P 21/20

(52) U.S. Cl. CPC H02P 21/22; H02P 21/18; H02P 21/20; H02P 2207/05

(57) ABSTRACT

A setpoint value determining unit (SVDU) checks whether a requested power (P) of an externally excited synchronous motor exceeds a maximum power value (Pmax). The SVDU addresses a first optimization problem (O1), and a second optimization problem (O2). To solve (O1), the SVDU determines a current vector (i) that includes the field-forming component (Id), the torque-forming component (Iq) of the motor current (I), and the field current (Ie) to reach a setpoint torque (M*) and minimize the losses (V) of the motor. To solve (O2), the SVDU determines the current vector (i) to minimize the resulting actual torque (M). In all cases, the SVDU takes into account the boundary conditions according to which the motor current (I) reaches a maximum value (Imax), the field current (Ie) reaches a maximum value (Iemax), and the motor voltage (U) reaches a maximum value (Umax).

### TECHNICAL FIELD

The present invention is based on an operating method for an externally excited synchronous motor comprising an excitation winding and a motor winding,
wherein a setpoint value determining unit receives an instantaneous rotational speed of the synchronous motor and a setpoint torque to be applied by the synchronous motor,
wherein the setpoint value determining unit determines in each case a setpoint value for an excitation current to be supplied to the excitation winding and a motor current to be supplied to the motor winding,
wherein the setpoint value determining unit specifies the determined setpoint values as setpoint values to a current control device for a converter device, so that the current control device actuates the converter device in such a way that the converter device supplies the excitation current to the excitation winding and the motor current to the motor winding.

The present invention is furthermore based on a computer program for a setpoint value determining unit, wherein the computer program comprises machine code which can be executed by the setpoint value determining unit, wherein the execution of the machine code by the setpoint value determining unit has the effect that the setpoint value determining unit carries out an operating method of this type.

The present invention is furthermore based on a setpoint value determining unit for determining setpoint values for an excitation current and a motor current of an externally excited synchronous motor, wherein the setpoint value determining device is programmed with a computer program of this type, so that it carries out an operating method of this type during operation.

The present invention is furthermore based on a drive,
wherein the drive has an externally excited synchronous motor with an excitation winding and a motor winding,
wherein the drive has a converter device which is connected to the excitation winding for supplying an excitation current and to the motor winding for supplying a motor current,
wherein the drive has a current control device which actuates the converter device,
wherein the drive has a setpoint value determining unit of this type,
wherein the setpoint value determining unit has inputs for receiving an instantaneous rotational speed of the synchronous motor and a setpoint torque to be applied by the synchronous motor,
wherein the setpoint value determining unit is connected to the current control device for the specification of a value for a field-forming component of the motor current and a value for a torque-forming component of the motor current and a value for the excitation current.

### PRIOR ART

In recent years, the use of externally excited synchronous motors (EESMs) has seen a sharp increase. This is due to high efficiency over the entire operating range and the high torque when starting up. A further advantage, particularly in comparison with the permanent-magnet synchronous machine (PMSM), is that materials with low availability are not required, in particular rare earths. In addition, the magnetic flux of the rotor, which can be adjusted via the excitation current, represents an additional degree of freedom, which allows the desired torque to be achieved in an energy-efficient and flexible manner.

The torque of an EESM is normally controlled in the field-oriented coordinates. For this purpose, a calculation of setpoint currents from the specification of the torque to be achieved depending on the motor parameters, the converter data and the present rotational speed is required. Conditions for these setpoint currents are, in particular, that a required torque is achieved as best as possible and that losses continue to be as low as possible. The calculation must be completed within a control cycle and thus have a real-time capability. Physical restrictions such as the maximum available voltage of the converter device and the maximum current in the motor, for example, must be observed and therefore taken into account in the calculation.

In the prior art, the current components of the motor current, that is to say the field-forming and the torque-forming components, as well as the excitation current are determined partly independently of each other. The setpoint torque to be applied is supplied to a current filter, which uses filtering to determine a setpoint value for the torque-forming current component of the motor current (usually referred to as q current) and specifies this setpoint value to the current control device. In addition, the maximum value of the motor voltage and the present motor voltage are supplied to a field-weakening controller. On the one hand, the field-weakening controller determines the setpoint value for the excitation current and specifies this setpoint value to the current control device. The field-weakening controller also determines a provisional setpoint value for the field-forming component of the motor current (usually referred to as d current). Based on the present rotational speed of the synchronous motor, a correction value for the setpoint value for the field-forming component of the motor current is determined using a characteristic curve. The final setpoint value for the field-forming component of the motor current is determined by adding this correction value to the provisional setpoint value for the field-forming component of the motor current. The final setpoint value for the field-forming component of the motor current is again specified to the current control device.

Other approaches to EESMs address this issue. However, it is only subproblems that are always solved. Furthermore, the solutions do not have real-time capability. Other methods from the prior art consider only the basic rotational speed range (in which operation without field weakening is possible) and use characteristic curves for the field-weakening controller in the field-weakening range, that is to say for high rotational speeds. These methods therefore require characteristic curves which must be recorded in advance. In addition, the motor current and the excitation current are considered independently of one another, resulting in sub-optimal solutions.

It is also known in the prior art to use look-up tables, which have been optimized offline, for the currents in order to find an optimal operating point depending on the present rotational speed and the requested torque. However, this solution requires a very large amount of measurement data and a certain amount of preparation. The look-up tables created in this way for the motor current and the excitation current are inflexible at runtime and must be completely adjusted when the machine parameters are changed. Furthermore, the look-up tables are very memory-intensive if they are to be used with high accuracy and depending on the motor parameters. DE 10 2014 223 014 A1 discloses an operating method for an externally excited synchronous motor comprising an excitation winding and a motor winding. In this operating method, a setpoint value determining unit receives an instantaneous rotational speed of the synchronous motor and a setpoint torque to be applied by the synchronous motor. Maximum values for an excitation current supplied to the excitation winding and a motor voltage that drives the motor current, as well as a power of the synchronous motor and also resistance values of the excitation winding and the motor winding are known to the setpoint value determining unit. The setpoint value determining unit sets an optimization problem for a current vector and solves it in real time. Each current vector has a component for a field-forming component of the motor current, a torque-forming component of the motor current, and the excitation current. The setpoint value determining unit determines the current vector in the context of the solution of the optimization problem in such a way that losses occurring in the excitation winding and the motor winding are minimized. The setpoint value determining unit determines the current vector in such a way that an actual torque of the synchronous motor resulting from the excitation current and the motor current corresponds to the setpoint torque. As a supplementary condition, the setpoint value determining unit takes into account the fact that the magnitude of the excitation current at most reaches the maximum value for the excitation current and the magnitude of the motor voltage at most reaches the maximum value for the motor voltage. The setpoint value determining unit specifies the components of the determined current vector as setpoint values to a current control device for a converter device, so that the current control device actuates the converter device in such a way that the converter device supplies the excitation current to the excitation winding and the motor current to the motor winding.

### SUMMARY OF THE INVENTION

The procedure from the prior art does not lead to optimum operation of the externally excited synchronous motor in all operating states. In particular, field weakening and thus the corresponding determination of a correction value for the setpoint value for the field-forming component of the motor current generally only takes place when the rotational speed of the externally excited synchronous motor is above a limit rotational speed.

There are procedures for a PMSM that can be used to determine the optimal mode of operation. However, the complexity and problem-solving ability in the case of a EESM is significantly greater than in the case of a PMSM. This also applies to the decision logic for finding the optimal solution.

The object of the present invention is to provide possibilities by means of which an externally excited synchronous motor can be operated in an optimized manner. In particular, losses of the synchronous motor should be minimized. The solution should have real-time capability.

The object is achieved by an operating method having the features of claim 1. Dependent claims 2 to 6 relate to advantageous embodiments of the operating method.

The invention provides an operating method for an externally excited synchronous motor, in which
a setpoint value determining unit receives an instantaneous rotational speed of the synchronous motor and a setpoint torque to be applied by the synchronous motor,
maximum values for an excitation current supplied to the excitation winding, a motor current supplied to the motor winding, a motor voltage driving the motor current, and a power of the synchronous motor are known to the setpoint value determining unit,
resistance values of the excitation winding and the motor winding are also known to the setpoint value determining unit,
the setpoint value determining unit checks whether a requested power of the synchronous motor given by the product of the instantaneous rotational speed and the setpoint torque to be applied exceeds the maximum value for the power,
the setpoint value determining unit, in the case that the requested power does not exceed the maximum value for the power, sets a first optimization problem for a current vector and solves it in real time and/or in the case that the requested power does exceed the maximum value for the power, sets a second optimization problem for the current vector and solves it in real time,
each current vector has a component for a field-forming component of the motor current, a torque-forming component of the motor current, and the excitation current,
the setpoint value determining unit determines the current vector in the context of the solution of the first optimization problem in such a way that losses occurring in the excitation winding and the motor winding are minimized,
the setpoint value determining unit takes the fact that an actual torque of the synchronous motor resulting from the excitation current and the motor current corresponds to the setpoint torque into account as a supplementary condition in the context of the first optimization problem,
the setpoint value determining unit also takes first general boundary conditions into account in the context of the first optimization problem, in accordance with which
   the magnitude of the motor current at most reaches the maximum value for motor current,
   the magnitude of the excitation current at most reaches the maximum value for the excitation current, and
   the magnitude of the motor voltage at most reaches the maximum value for the motor voltage,
the setpoint value determining unit determines the current vector in the context of the solution of the second optimization problem in such a way that the resulting actual torque of the synchronous motor is maximized,
the setpoint value determining unit takes the fact that the magnitude of the motor voltage is equal to the maximum value for the motor voltage into account as a supplementary condition in the context of the second optimization problem,
the setpoint value determining unit also takes second general boundary conditions into account in the context of the second optimization problem, in accordance with which
   the magnitude of the motor current at most reaches the maximum value for motor current, and
   the magnitude of the excitation current at most reaches the maximum value for the excitation current, and
the setpoint value determining unit specifies the components of the current vector determined by solving the first or the second optimization problem as setpoint values to a current control device for a converter device, so that the current control device actuates the converter device in such a way that the converter device supplies the excitation current to the excitation winding and the motor current to the motor winding.

This means that a uniform solution is provided for all relevant currents (field-forming component, torque-forming component, excitation current). As a result, the synchronous motor can be operated with minimal losses in any operating state in which the setpoint torque to be applied can be achieved. In any operating state in which the setpoint torque to be applied cannot be achieved, the synchronous motor can be operated in such a way that the torque of the synchronous motor is as close as possible to the setpoint torque to be applied.

The inventive solution is thus based on the determination of the motor current and the field current by solving a suitable optimization problem.

The first optimization problem cannot be solved in its entirety in general—at least in real time and currently available hardware in a form suitable for mass production. For the efficient solution of the first optimization problem, it is therefore preferably provided that, in the context of the solution of the first optimization problem, the setpoint value determining unit
initially provisionally determines the current vector without taking into account the first general boundary conditions,
then checks whether the provisionally determined current vector satisfies the first general boundary conditions,
uses the provisionally determined current vector as the current vector if the provisionally determined current vector satisfies the first general boundary conditions, and otherwise determines the current vector taking into account at least one of the following first specific boundary conditions, according to which
   the magnitude of the motor current is equal to the maximum value for motor current,
   the magnitude of the excitation current is equal to the maximum value for the excitation current, and
   the magnitude of the motor voltage is equal to the maximum value for the motor voltage, and,
depending on which of the first general boundary conditions are not satisfied, determines which of the first specific boundary conditions it takes into account.

This means that there is a division into analytically solvable or at least numerically approximately solvable sub-problems. In the cases that cannot be solved analytically, efficient numerical optimizations are used, which lead to the optimum operating point with few iterations. A decision tree is taken as a basis for deciding which of the sub-problems is actually solved and the solution thereto is then used. This procedure can significantly reduce the complexity of the determination, in particular, so that real-time capability can be guaranteed.

Provision is preferably made, in the context of checking whether the provisionally determined current vector satisfies the first general boundary conditions, for the setpoint value determining unit
to first check whether the magnitude of the motor current at most reaches the maximum value for the motor current and whether the magnitude of the excitation current at most reaches the maximum value for the excitation current, and
only then to check whether the magnitude of the motor voltage at most reaches the maximum value for the motor voltage.

This procedure quickly leads to the correct solution, that is to say the current vector, by means of a simple decision tree that is easy to process.

For the efficient solution of the second optimization problem, it is preferably provided that, in the context of the solution of the second optimization problem, the setpoint value determining unit
initially provisionally determines the current vector without taking into account the second general boundary conditions,
then checks whether the provisionally determined current vector satisfies the second general boundary conditions,
uses the provisionally determined current vector as the current vector if the provisionally determined current vector satisfies the second general boundary conditions, and otherwise determines the current vector taking into account at least one of the following second specific boundary conditions, according to which
   the magnitude of the motor current is equal to the maximum value for motor current, and
   the magnitude of the excitation current is equal to the maximum value for the excitation current, and
depending on which of the second general boundary conditions are not satisfied, determines which of the second specific boundary conditions it takes into account.

As a result, the complexity of the determination, in particular, can be significantly reduced so that real-time capability can be guaranteed.

Provision is preferably made, in the context of checking whether the provisionally determined current vector satisfies the second general boundary conditions, for the setpoint value determining unit
to first check whether the magnitude of the motor current at most reaches the maximum value for motor current, and
only then to check whether the magnitude of the excitation current at most reaches the maximum value for the excitation current.

This procedure quickly leads to the correct solution, that is to say the current vector, by means of a simple decision tree that is easy to process.

The setpoint value determining unit preferably only takes into account the copper losses as losses. The restriction to copper losses is a simplification. However, this simplification is justified because copper losses account for the majority of the total losses (at least 70%, often even 80% and more) and the synchronous motor also operates mostly in the base rotational speed range, in which copper losses are particularly dominant over iron losses.

The object is furthermore achieved by a computer program having the features of claim 7. According to the invention, the execution of the computer program by the setpoint value determining unit has the effect that the setpoint value determining unit carries out an operating method according to the invention.

The object is furthermore achieved by a setpoint value determining unit having the features of claim 8. According to the invention, the setpoint value determining unit is programmed with a computer program according to the invention, so that the setpoint value determining unit carries out an operating method according to the invention during operation.

The object is furthermore achieved by a drive having the features of claim 9. According to the invention, in a drive of the type mentioned at the beginning, the setpoint value determining unit is in the form of a setpoint value determining unit according to the invention.

### BRIEF DESCRIPTION OF THE DRAWINGS

The above-described properties, features and advantages of the present invention and the manner in which they are achieved will become clearer and more easily understandable in connection with the following description of the exemplary embodiments, which are explained in more detail in association with the drawings, in which, in a schematic illustration:

FIG. 1 shows a drive,

FIG. 2 shows a flow diagram,

FIG. 3 shows a first optimization problem,

FIG. 4 shows a flow diagram,

FIG. 5 shows a second optimization problem and

FIG. 6 shows a flow diagram.

### DESCRIPTION OF THE EMBODIMENTS

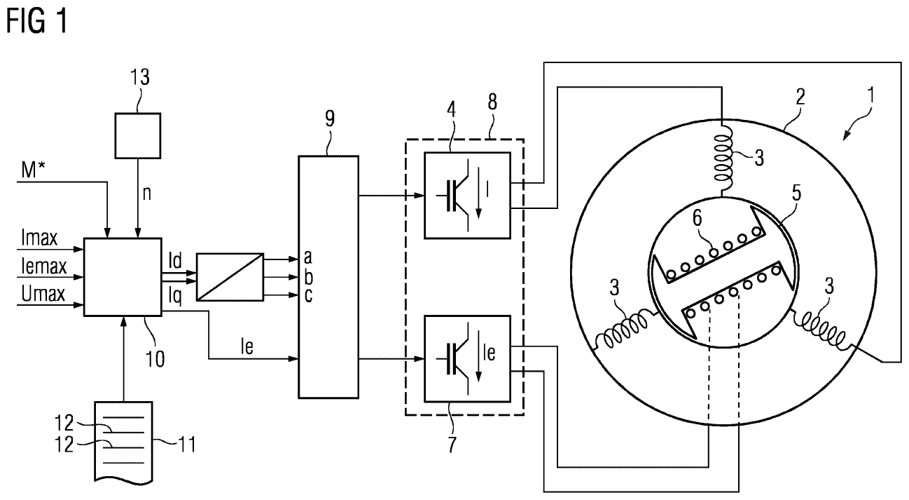

According to FIG. 1, a drive has an externally excited synchronous motor 1. The synchronous motor 1 has a stator 2 with a motor winding 3 arranged therein. A motor current I is supplied to the motor winding 3 via a converter 4. The motor winding 3 is usually in the form of a three-phase winding. The motor current I therefore comprises the phases a, b, c of a three-phase system. The synchronous motor 1 also has a rotor 5 with a co-rotating excitation winding 6. An excitation current Ie is supplied to the excitation winding 6 via another converter 7. The excitation current Ie is usually a direct current. The converter 4 and the converter 7 together form a converter device 8. The converter device 8 is actuated by a current control device 9.

The drive also has a setpoint value determining unit 10. The setpoint value determining unit 10 specifies a field-forming component Id and a torque-forming component Iq of the motor current I and the excitation current Ie as setpoint values to the current control device 9. The field-forming component Id and the torque-forming component Iq together form the setpoint value for the motor current I. The two components Id, Iq are rotated 90° with respect to one another. The motor current I is thus, insofar as it concerns the internal handling of the motor current I in the setpoint value determining unit 10 and the specification of the setpoint values to the current control device 9, a vector variable, wherein in the (co-rotating) dq system the relationship

$${Id}^{2} + {Iq}^{2} = {\vert I \vert}^{2} \qquad ( 1 )$$

applies.

Due to the specification of the mentioned setpoint values Id, Iq and Ie, the current control device 9 is able to actuate the converter device 8 in such a way that the converter 7 supplies the excitation current Ie to the excitation winding 6 and the converter 4 supplies the motor current I to the motor winding 3. The conversion from the co-rotating dq system to the abc system is familiar to experts in the art and does not need to be explained in more detail.

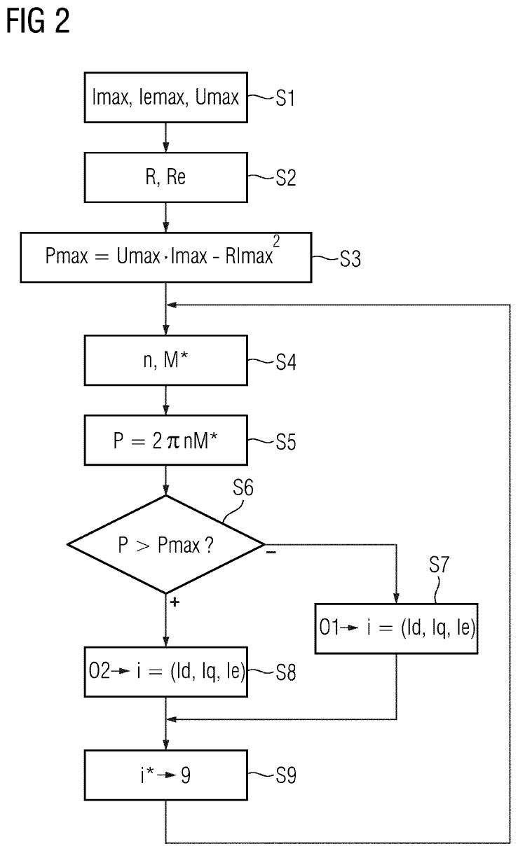

The setpoint value determining unit 10 is the actual core subject of the present invention. The setpoint value determining unit 10 is programmed with a computer program 11. The computer program 11 comprises machine code 12, which can be executed by the setpoint value determining unit 10. Due to the processing of the machine code 12 by the setpoint value determining unit 10, the setpoint value determining unit 10 carries out an operating method, which is explained in more detail below first in conjunction with FIG. 2, then with additional reference to the further FIG.

In accordance with FIG. 2, the values Lmax, Iemax and Umax are known to the setpoint value determining unit 10 in a step S1. The mentioned values Lmax, Iemax and Umax can be determined, for example, by the computer program 11 or can be fixed once during start-up of the drive. If necessary, they can also be determined dynamically as a function of a state of the drive, for example as a function of the operating temperature of the synchronous motor 1.

The value Lmax is the maximum value for the magnitude of the motor current I. The value Iemax is the maximum value for the magnitude of the excitation current Ie. The value Umax is the maximum value for the magnitude of a motor voltage U that drives the motor current I. The maximum value Umax for the motor voltage U can be determined, for example, by the supply voltage of the converter 4, for example, a DC link voltage present on the input side of the converter 4.

In the co-rotating dq system, the motor voltage U also has a d and a q component-analogous to the motor current I-herein-after referred to as field-forming and torque-forming voltage components Ud and Uq. In the same way as the motor current I, the following relationship applies:

$${Ud}^{2} + {Uq}^{2} = {\vert U \vert}^{2} \qquad ( 2 )$$

In a step S2, the resistance R of the motor winding 3 and the resistance Re of the excitation winding 6 are also known to the setpoint value determining unit 10. The values R, Re can also be determined, for example, by the computer program 11 or can be fixed once during start-up of the drive.

The components Ud, Uq of the motor voltage U and an excitation voltage Ue and the components Id, Iq of the motor current I and the excitation current Ie can be related to one another based on the variables given now. This is because, in the case of steady-state operation, the following apply with a good approximation:

$$Ud = R \cdot Id - ω \cdot Lq \cdot Iq \qquad ( 3 )$$

$$Uq = R \cdot Iq + ω \cdot ( Ld \cdot Id + Lm \cdot Ie ) \qquad ( 4 )$$

$$Ue = Re \cdot Ie \qquad ( 5 )$$

In equations 3 to 5, ω is the electrical angular frequency. Ld and Lq are the self-inductances of the motor winding 3 in the d and q axes. Lm is the counter-inductance of the excitation winding 6.

Equation 5 also shows indirectly that the maximum excitation voltage Ue does not have to be explicitly taken into account, as it is in a linear relationship with the excitation current Ie. The maximum value Iemax can therefore be determined in such a way that it corresponds to the earlier limitation (excitation current Ie or excitation voltage Ue).

Equations 3 to 5 do not take into account influences resulting from a change in the motor current I and excitation current Ie over time. This is permissible because these changes and the resulting influences are small. Equations 3 to 5 also assume that the resistances R, Re are constant over time. However, any temperature dependence or dependence on a different drive state can be taken into account without any problems.

The self-inductances Ld and Lq of the motor winding 3 and also the counter-inductance Lm of the excitation winding 6 depend on the components Id, Iq of the motor current I and the excitation current Ie. If necessary, the specific values for the self-inductances Ld and Lq of the motor winding 3 and the counter-inductance Lm of the excitation winding 6 can be stored in look-up tables within the setpoint value determining unit 10.

A maximum value Pmax for a power P of the synchronous motor 1 is also known to the setpoint value determining unit 10. It is possible that the maximum value Pmax for the power P of the synchronous motor 1 is explicitly specified to the setpoint value determining unit 10. Alternatively, it is possible that the setpoint value determining unit 10 in a step S3 determines the maximum value Pmax itself according to the relationship

$$P max = U max \cdot Im ax - R \cdot Im {ax}^{2} \qquad ( 6 )$$

In a step S4, the setpoint value determining unit 10 receives an instantaneous (mechanical) rotational speed n of the synchronous motor 1 and a setpoint torque M* to be applied by the synchronous motor 1. The manner in which the setpoint torque M* is specified may be of any nature. As such, it is not the subject of the present invention. As such, the manner in which the instantaneous rotational speed n is specified is not the subject matter of the present invention either. For example, the drive may have a determination block 13, which determines the rotational speed n based on the actual operating state of the synchronous motor 1. Alternatively, instead of the rotational speed n, the electrical angular frequency ω can be determined and the rotational speed n can be calculated therefrom. Appropriate procedures for determining the electrical angular frequency ω and also the calculation of the rotational speed n from the electrical angular frequency ω are generally known to experts in the art. It is also subsequently assumed that the setpoint torque M* has a positive value. A negative value for the setpoint torque M* would only affect signs, but the magnitudes for the field-forming component Id, the torque-forming component Iq and the excitation current Ie would not change.

In a step S5, the setpoint value determining unit determines an instantaneously requested power P of the synchronous motor 1. The instantaneously requested power P of the synchronous motor 1 is given by the product of the instantaneous rotational speed n and the target torque M* to be applied.

In a step S6, the setpoint value determining unit 10 checks whether the instantaneously requested power P exceeds the maximum value Pmax. If the requested power P does not exceed the maximum value Pmax, the setpoint value determining unit 10 passes to a step S7. In step S7, the setpoint value determining unit 10 sets a first optimization problem O1 for a current vector i and solves it in real time. On the other hand, if the requested power P does exceed the maximum value Pmax, the setpoint value determining unit 10 passes to a step S8. In step S8, the setpoint value determining unit 10 sets a second optimization problem O2 for the current vector i and solves it in real time.

The current vector i comprises three components, specifically the field-forming component Id and the torque-forming component Iq of the motor current I and the excitation current Ie. The solution of the first or second optimization problem O1, O2 are thus the values that the setpoint value determining unit 10 specifies as setpoint values to the current control device 9. This specification takes place in step S9.

It is possible to supplement the procedure of FIG. 2 in that the setpoint value determining unit 10, in the event that it solves the second optimization problem O2, outputs a message to a higher-level device (not shown). This allows the higher-level device to be informed that the requested setpoint torque M* cannot be provided.

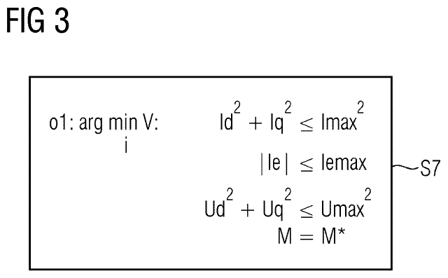

In the context of the solution of the first optimization problem O1, the setpoint value determining unit 10 determines the current vector i according to FIG. 3 in such a way that losses V occurring are minimized. In the context of the present invention, only the copper losses occurring in the excitation winding 6 and the motor winding 3 are taken into account. The other losses—in particular iron losses—can be disregarded, as in practice copper losses VK are significantly greater than the other losses.

The copper losses VK can be set in good approximation in the form of the relationship

$$VK = \frac{3}{2} \cdot R \cdot ( {Id}^{2} + {Iq}^{2} ) + Re \cdot {Ie}^{2} \qquad ( 7 )$$

In the context of the first optimization problem O1, the setpoint value determining unit 10 takes into account as a supplementary condition the basic prerequisite of the first optimization problem O1 that an actual torque M of the synchronous motor 1 corresponds to the setpoint torque M*. The actual torque M is determined by the excitation current Ie and the components Iq, Id of the motor current I. The result is a good approximation of

$$M = \frac{3}{2} Z \cdot ( Lm \cdot Ie + ( Ld - Lq ) \cdot Id ) \cdot Iq \qquad ( 8 )$$

Z is the number of pole pairs of the synchronous machine 1.

The setpoint value determining unit 10 also takes first general boundary conditions into account in the context of the first optimization problem O1. In accordance with these boundary conditions, it is required that
the magnitude of the motor current I at most reaches the maximum value Lmax for motor current I,
the magnitude of the excitation current Ie at most reaches the maximum value Iemax for the excitation current Ie, and
the magnitude of the motor voltage U at most reaches the maximum value Umax for the motor voltage U.

Mathematically, the first optimization problem O1 can be formulated as follows:

$$i = arg {min}_{i} V \qquad ( 9 )$$

taking into account

$${Id}^{2} + {Iq}^{2} \leq I {max}^{2} \qquad ( 10 )$$

$$\vert Ie \vert \leq Ie max \qquad ( 11 )$$

$${Ud}^{2} + {Uq}^{2} \leq U {max}^{2} \qquad ( 12 )$$

$$M = {M}^{*} \qquad ( 13 )$$

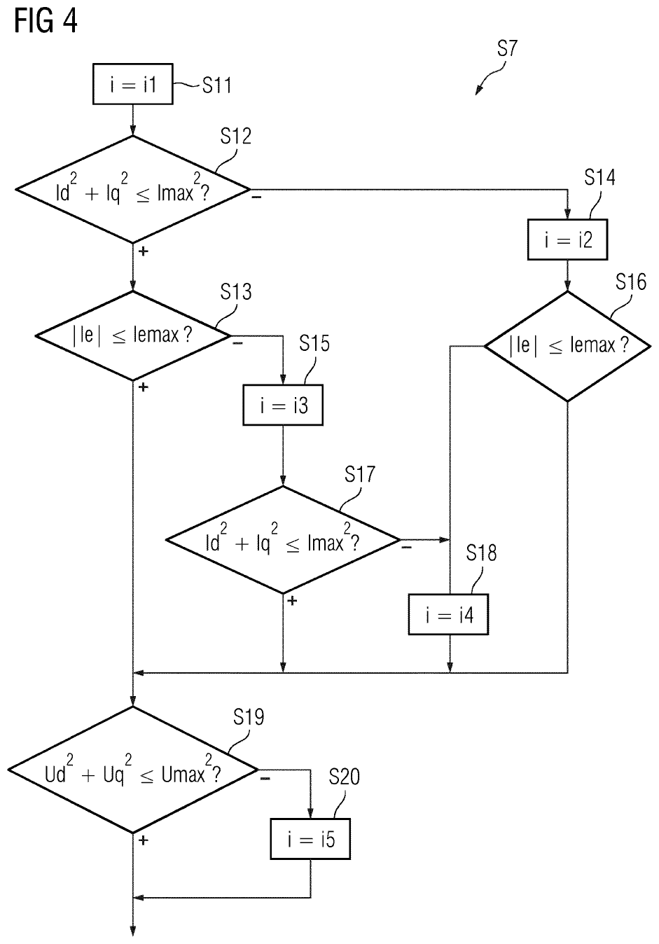

Solving the first optimization problem O1 is not a trivial task, since the actual torque M is dependent in a complex way on the components of the current vector i and the non-linear limitations according to inequalities 10 to 12 must also be taken into account. The exact procedure for solving the first optimization problem O1 is explained in more detail below in conjunction with FIG. 4.

FIG. 4 shows the specific procedure by means of which the setpoint value determining unit 10 determines the current vector i in the context of the solution of the first optimization problem O1.

In accordance with FIG. 4, the setpoint value determining unit 10 first determines the current vector i=i1 in a step S11. The current vector i1 is determined by the setpoint value determining unit 10 without taking into account the first general boundary conditions. It does solve the first optimization problem O1 according to equation 9, taking equation 13 into account. However, it solves the optimization problem O1 without taking into account the inequalities 10 to 12 at the same time.

In practice, step S11 can be solved precisely analytically, for example using a Lagrange approach. This solution is known from the literature. A purely exemplary reference can be made to the paper “Optimal current control of externally excited synchronous machines in automotive traction drive applications” by O. Haala, B. Wagner, M. Hofmann and M. Marz, published in the International Journal of Electrical and Computer Engineering, volume 7 (2013), pages 1133 to 1139. The reference book “Electric drives: control of drive systems” by D. Schroder, Springer-Verlag, 2009 may also be mentioned. The solution is independent of the rotational speed n or the electrical angular frequency ω. This is known in professional circles as Maximum Torque Per Current (MTPC).

The solution determined in step S11 is provisional only. Before the setpoint value determining unit 10 adopts the current vector i=i1 as the final current vector i, the setpoint value determining unit 10 first checks in a step S12 whether the magnitude of the motor current I at most reaches the maximum value Lmax for the motor current I. If this condition is satisfied, the setpoint value determining unit 10 then checks in a step S13 whether the magnitude of the excitation current Ie at most reaches the maximum value Iemax for the excitation current Ie.

If the check in step S12 is already negative, that is to say if the magnitude of the motor current I for the current vector i1 is greater than the maximum value Lmax for the motor current I, the setpoint value determining unit 10 determines the current vector i=i2 in a step S14. The current vector i2 is determined by the setpoint value determining unit 10 as before by solving equation 9, taking equation 13 into account. However, it solves equation 9, also taking the first specific boundary condition

$${Id}^{2} + {Iq}^{2} = I {max}^{2} \qquad ( 14 )$$

into consideration. Due to this boundary condition, the term to be minimized in equation 9 can be simplified significantly. This is because the component R(Id²+Iq²) is a constant based on equation 14, which has the value RImax² and can therefore be disregarded within the scope of minimization. As a result, the resistance Re can also be disregarded, as it is only a constant factor. Instead of minimizing (all of the) copper losses VK, it is therefore sufficient to minimize the term Ie². Strictly speaking, it is even sufficient to minimize the magnitude of the excitation current Ie. Furthermore, on the basis of equation 14, the magnitude of the torque-generating component Iq can be determined on the basis of the value of the field-forming component Id, so that a variable has to be varied less in the result. In practice, step S14 can also be solved analytically using a Lagrange approach.

If the current vector i passes the check in step S12, but not the check in step S13, the setpoint value determining unit 10 determines the current vector i=i3 in step S15. The setpoint value determining unit 10 determines the current vector i3 as before by solving equation 9, taking equation 13 into account. However, it solves equation 9, taking the first specific boundary condition

$$\vert Ie \vert = Ie max \qquad ( 15 )$$

into consideration.

Step S15 has the solution of the MTPC trajectory of a permanent-excited synchronous machine. This solution is known from the literature. Reference can be made purely by way of example to the paper “Analytical solutions for the optimal reference currents for MTPC/MTPA, MTPV and MTPF control of anisotropic synchronous machines” by H. Eldeeb, C. M. Hackl, J. Kullick, and L. Horlbeck, published in Proc. 2017 IEEE International Electric Machines and Drives Conference (IEMDC), 2017, pages 1 to 6. Reference can also be made to the paper “Optimal setpoint computation for constrained torque control of PMSMs” by T. Englert and K. Graichen, published in Proc. 2018 European Control Conference (ECC), 2018, pages 2671 to 2677.

Analogously to the procedure for determining the current vector i=i2, the term to be minimized in the context of equation 9 can also be significantly simplified when determining the current vector i=i3. This is because the component ReIe² is a constant based on equation 15, which has the value Relemax² and can therefore be disregarded within the scope of minimization. As a result, the factor 3R/2 can also be disregarded, as it is only a constant factor. Instead of minimizing (all of the) copper losses VK, it is therefore sufficient to minimize term Id²+Iq². Furthermore, a variable has to be varied less on account of equation 15. This is because the magnitude of the excitation current Ie is fixed. The excitation current Ie can therefore only have the values +Iemax or −Iemax.

The current vectors i=i2 and i=i3 of steps S14 and S15 are also only provisional. Before the setpoint value determining unit 10 adopts the current vector i=i2 or the current vector i=i3 as the final current vector i, the setpoint value determining unit 10 checks in steps S16 or S17 whether the current condition remaining in each case is satisfied, that is to say whether inequality 11 is satisfied in the case of the current vector i=i2 or inequality 10 is satisfied in the case of the current vector i=i3. If, in one case, the current vector i=i2 does not satisfy inequality 11 or, in the other case, the current vector i=i3 does not satisfy inequality 10, the setpoint value determining unit 10 determines the current vector i=i4 in a step S18. The current vector i4 is determined by the setpoint value determining unit 10 as before by solving equation 9, taking equation 13 into account. However, it solves equation 9, taking into account the conditions of equation 14 and equation 15 at the same time.

The solution of step S18 is (almost) trivial, since the result is that only the field-forming component Id has to be varied. The torque-forming component Iq is thus fixed-except for its sign. Likewise, the excitation current Ie is also fixed except for its sign.

Alternatives to the configuration of steps S11 to S18 are also possible. In particular, it is possible to carry out the checks in steps S12 and S13 in the reverse order and thus primarily not to determine the current vector i=i2, but the current vector i=i3. Even better is a procedure in which the checks in steps S12 and S13 are combined. If the current vector i=i1 does not pass only one of the two checks in the context of this configuration, the setpoint value determining unit 10 determines the two current vectors i=i2 and i=i3 and checks for both current vectors i=i2 and i=i3 whether they pass the respective other check. The setpoint value determining unit 10 thus checks whether the current vector i=i2 satisfies the condition of inequality 11 and the current vector i=i3 satisfies the condition of inequality 10. If both the current vector i=i2 and the current vector i=i3 pass their respective checks, the setpoint value determining unit 10 selects the current vector i of the two current vectors i=i2 and i=i3 that has the lower copper losses VK. If only one of the two current vectors i=i2 and i=i3 passes its check, while the other of the two current vectors i=i2 and i=i3 fails its check, the setpoint value determining unit 10 selects that one of the two current vectors i=i2 and i=i3 that passes its check as the current vector i. If both current vectors i=i2 and i=i3 do not pass their respective check, the setpoint value determining unit 10 continues with the determination of the current vector i=i4.

The current vector i now determined satisfies the current limits of inequalities 10 and 11, regardless of whether it is the current vector i1, i2, i3 or i4. However, it is not yet guaranteed that the voltage limitation according to inequality 12 is also satisfied. The setpoint value determining unit 10 therefore checks in a step S19 whether the determined current vector i meets the condition of inequality 12. The setpoint value determining unit 10 thus checks whether the magnitude of the motor voltage U at most reaches the maximum value Umax for the motor voltage U.

If the current vector i passes the check in step S19, the setpoint value determining unit 10 uses the current vector i determined by the execution of steps S11 to S18. Otherwise, the setpoint value determining unit 10 determines the current vector i=i5 in a step S20. The current vector i5 is determined by the setpoint value determining unit 10 as before by solving equation 9, taking equation 13 into account. However, it solves equation 9, at the same time taking the first specific boundary condition

$${Ud}^{2} + {Uq}^{2} = U {max}^{2} \qquad ( 16 )$$

into consideration.

To determine the current vector i=i5, it may be necessary to calculate the current vector i=i5 numerically. Various determination methods are available to a person skilled in the art for this purpose.

For example, it is possible to solve the current vector i=i5 using gradient methods with line search methods or multidimensional Newton's methods. However, these methods run the risk of taking too much time. However, due to the structure of the optimization problem for the current vector i=i5, analytical partial solutions can be determined and therefore very efficient numerical methods can be derived.

An example of such a method is fixed-point iteration for the excitation current Ie. In this case, the necessary optimality conditions of the first order of the optimization problem are determined by means of the Lagrange approach

$$La ( i , λ1 , λ2 ) = {i}^{T} \cdot {R}^{′} \cdot i + λ1 \cdot ( {i}^{T} \cdot {M}^{′} \cdot i - {M}^{*} ) + λ2 \cdot ( {i}^{T} \cdot {U}^{′} \cdot i - U {max}^{2} ) \qquad ( 17 )$$

La is the Lagrange function. λ1 and λ2 are Lagrange multipliers. R′, M′ and U′ are 3×3 matrices, which can be determined using the resistances R, Re, the generated torque M and the voltage components Ud and Uq as well as the excitation voltage Ue in conjunction with the boundary conditions to be observed (equations 13 and 16). The gradient

$$\frac{\hat{o} La ( i , λ 1 , λ 2 )}{\partial } = 2 ( {R}^{′} + λ1 \cdot {M}^{′} + λ2 \cdot {U}^{′} ) \cdot i \qquad ( 18 )$$

must as a minimum satisfy the condition

$$( {R}^{′} + λ1 \cdot {M}^{′} + λ2 \cdot {U}^{′} ) \cdot i = 0 \qquad ( 19 )$$

This condition can be used to calculate the excitation current Ie and the Lagrange multipliers λ1 and λ2 as a function of the components Id, Iq of the motor current I. Specifically, the following function exists

$$Ie = {f}_{Ie} ( Id , Iq ) \qquad ( 20 )$$

The solution of this function does not depend on the Lagrange multipliers λ1 and λ2.

In an analogous manner, this can be applied to the boundary conditions for the torque M (equation 13) and the motor voltage U (equation 16). The field-forming component Id and the torque-forming component Iq of the motor current I can be calculated as a function of the excitation current Ie as functions

$$Id = {f}_{Id} ( Ie ) \qquad ( 21 )$$

$$and$$

$$Iq = {f}_{Iq} ( Ie ) \qquad ( 22 )$$

Based on the functions F_{Ie}, F_{Id} and F_{Iq}, an iterative solution method in the form of a fixed-point iteration

$$Ie ( k + 1 ) = {f}_{Ie} ( {f}_{Id} ( Ie ( k ) , {f}_{Iq} ( Ie ( k ) ) \qquad ( 23 )$$

can be formulated, where k is the respective iteration step. The fixed point of the iteration rule is then the optimal current vector i=i5, and the Lagrange multipliers λ1 and λ2 can be calculated analytically.

The iteration is terminated at an appropriate time to ensure real-time capability. For example, the termination criterion may be that a maximum number of iterations are performed or that the result changes only marginally. By using an appropriate initial starting point, the actual solution results in very few iteration steps. The initial starting point may be, for example, the excitation current Ie that was last output by the setpoint value determining unit 10 to the current control device 9. However, other approaches are also possible.

Alternatively, a one-dimensional method can be used to determine a zero of a function. These methods are very efficient. In this case, it is assumed that equation 19 must have a non-trivial solution. Consequently, the matrix

$${R}^{′} + λ1 \cdot {M}^{′} + λ2 \cdot {U}^{′} \qquad ( 24 )$$

must have a kernel, and the determinant of the matrix must have a value of 0. This allows expression 24 to be resolved to λl or λ2. For example, λl can be displayed as a function of λ2. This results in the solutions for the optimal current vector i=i5, because the current vector i=i5 must be the kernel of the matrix in order for the gradient equation to be satisfied. The following must thus hold true

$$ker n ( {R}^{′} + λ1 \cdot {M}^{′} + λ2 \cdot {U}^{′} ) = IL \cdot i ( λ 2 ) \qquad ( 25 )$$

Here, i(λ2) is a current vector of length 1, which thus determines the “direction” of the current vector i=i5, that is to say the ratio of the three components of the current vector i=i5. The length IL is determined by the conditions of equations 13 and 16. This is because the following thus hold true

$${IL}^{2} \cdot {i ( λ 2 )}^{T} \cdot {R}^{′} \cdot i ( λ 2 ) = {M}^{*} \qquad ( 26 )$$

$$and$$

$${IL}^{2} \cdot {i ( λ 2 )}^{T} \cdot {U}^{′} \cdot i ( λ 2 ) = U {max}^{2} \qquad ( 27 )$$

Resolving equations 26 and 27 according to IL² and equalization results in the equation

$$U {max}^{2} \cdot {i ( λ 2 )}^{T} \cdot {M}^{′} \cdot i ( λ 2 ) - {M}^{*} \cdot {i ( λ 2 )}^{T} \cdot {U}^{′} \cdot i ( λ 2 ) = 0 \qquad ( 28 )$$

In equation 28, only λ2 is unknown. Equation 28 can therefore be resolved from the outset according to λ2. However, no closed-form analytical solution is known for equation 28. However, to determine the zero, that is to say the specific value of λ2, generally known methods for zero determination can be used, for example Newton's method or the method of halving the interval.

After solving equation 28 numerically, the components Id, Iq of the motor current I and λ1 can be calculated analytically. In turn, the optimum from the calculation step can be used for an initial solution prior to this.

Of course, other solution methods can also be used.

In the context of the procedures described, it must also be ensured that the solution found is within the permissible current range. Equations 13 (in conjunction with equations 8), 14 and 16 can be solved analytically to verify this fact. This results in a calculated minimum value and a calculated maximum value for the excitation current Ie and these must be observed. If the calculated minimum value is less than 0, it is raised to the value of 0. If the calculated maximum value is greater than the maximum excitation current Lmax, the maximum excitation current Lmax is used instead of the calculated maximum value. If the excitation current Ie of the current vector i=i5 is outside the operating range defined in this way, the calculated minimum value is the optimal solution. This ensures that the current restrictions are observed and that a valid solution that meets all the restrictions and at the same time provides the requested torque M* can always be found.

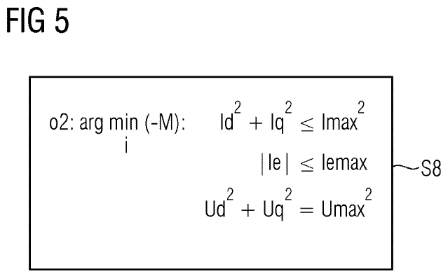

In the context of the solution of the second optimization problem O2, the setpoint value determining unit 10 determines the current vector i according to FIG. 5 in such a way that the actual torque M of the synchronous motor 1 is maximized, with the result that the actual torque M thus approximates the setpoint torque M* as far as possible. The losses V and, in particular, the copper losses VK as well are not taken into account in the solution of the second optimization problem O2.

In the context of the second optimization problem O2, the setpoint value determining unit 10 takes the fact that equation 16 is satisfied into account as a supplementary condition. In terms of content, this corresponds to the attempt to actuate the converter 4 as far as possible so that the actual torque M of the synchronous motor 1 is maximized.

The setpoint value determining unit 10 also takes second general boundary conditions into account in the context of the second optimization problem O2. In accordance with these boundary conditions, it is required that
the magnitude of the motor current I at most reaches the maximum value Lmax for the motor current I (inequality 10) and
the magnitude of the excitation current Ie at most reaches the maximum value Iemax for the excitation current Ie (inequality 11).

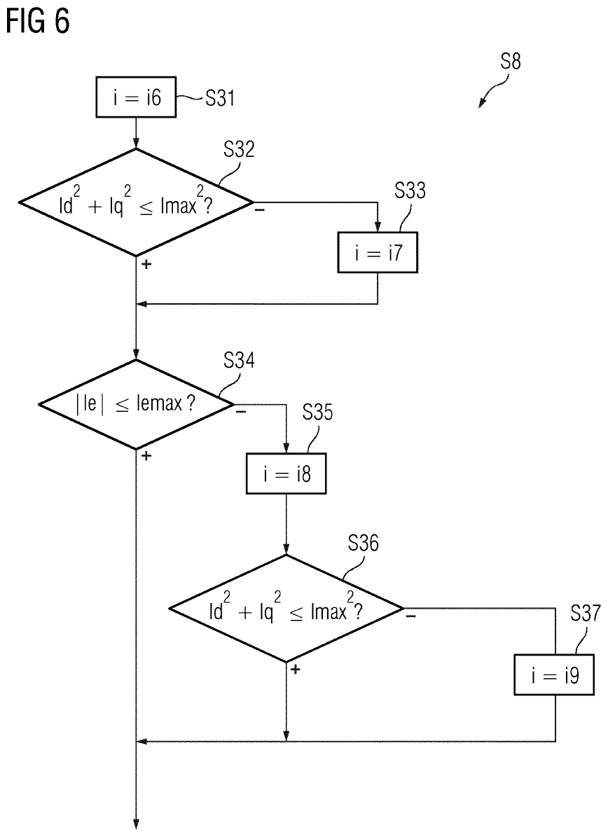

Mathematically, the second optimization problem O2 can be formulated as follows:

$$i = arg {min}_{i} ( - M ) \qquad ( 29 )$$

wherein the setpoint value determining unit 10 also takes equation 16 and the inequalities 10 and 11 into account. The exact procedure for solving the second optimization problem O2 is explained in more detail in conjunction with FIG. 6.

FIG. 6 shows the specific procedure by means of which the setpoint value determining unit 10 determines the current vector i in the context of the solution of the second optimization problem O2.

In accordance with FIG. 6, the setpoint value determining unit 10 first determines the current vector i as current vector i6 in a step S31. The current vector i6 is determined by the setpoint value determining unit 10 without taking into account the second general boundary conditions. It does solve the second optimization problem O2 according to equation 29, additionally taking equation 16 into account. The setpoint value determining unit 10 does not take into account inequalities 10 and 11 in step S31.

In practice, step S31 can be solved precisely analytically, for example using a Lagrange approach. This solution may be carried out analogously to the determination of current vectors i2 and 13.

The solution determined in step S31 is provisional only. Before the setpoint value determining unit 10 adopts the current vector i6 as the final current vector i, the setpoint value determining unit 10 first checks in a step S32 whether the magnitude of the motor current I at most reaches the maximum value Lmax for the motor current I.

If the current vector i=i6 does not pass the check in step S32, the setpoint value determining unit 10 determines the current vector i as current vector i7 in a step S33. In step S34, the setpoint value determining unit 10 solves equation 29 again. However, it also takes into account not only equation 16, but also equation 14.

Then the setpoint value determining unit 10 checks in a step S34 whether the now determined current vector i-regardless of whether it is the current vector i6 or i7-meets the condition that the excitation current Ie satisfies inequality 11, that is to say the magnitude of the excitation current Ie at most reaches the maximum value Iemax for the excitation current Ie.

If the current vector i passes the check in step S34, the setpoint value determining unit 10 uses the current vector i, that is to say the current vector i=i6 or the current vector i=i7, which is the basis for the check. If the current vector i does not pass the check in step S34, the setpoint value determining unit 10 determines the current vector i8 as current vector i in a step S35. In step S35, the setpoint value determining unit 10 solves equation 29 again. However, it also takes into account not only equation 16, but also equation 15.

Analogously to the procedures for the current vectors i=i2 and i=i3, a variable also has to be varied less when determining the current vectors i=i7 and i=i8 because the magnitude of the torque-forming component Iq can be determined based on the value of the field-forming component Id or the magnitude of the excitation current Ie is fixed.

In step S35, another optimization problem has to be solved. This optimization problem maximizes the torque M with the maximum value Iemax of the excitation current Ie while observing the voltage limitation according to equation 16. This optimization problem is known for permanent-magnet synchronous machines and has an analytical solution there. The solution trajectory is referred to in the literature as Maximum Torque Per Voltage (MTPV) and is known, for example, from the previously mentioned documents “Analytical solutions for the optimal reference currents for MTPC/MTPA, MTPV and MTPF control of anisotropic synchronous machines” by H. Eldeeb et al. and “Optimal setpoint computation for constrained torque control of PMSMs” by T. Englert and K. Graichen. Said solution trajectory can be adopted in a 1:1 ratio.

In practice, step S35 can be solved precisely analytically, for example using a Lagrange approach.

In a step S36, the setpoint value determining unit 10 checks, for the current vector i=i8, whether the magnitude of the motor current I at most reaches the maximum value Lmax for the motor current I. If the current vector i passes the check in step S36, the setpoint value determining unit 10 uses the current vector i=i8 determined in step S35. If the current vector i does not pass the check in step S36, the setpoint value determining unit 10 determines the current vector i=i9 in a step S37. As part of the determination of the current vector i9, the setpoint value determining unit 10 solves equation 29 again. However, it also takes into account not only equation 16, but also equation 14.

This optimization problem is known for permanent-magnet synchronous machines and has an analytical solution there. The solution is known, for example, from the previously mentioned sources “Analytical solutions for the optimal reference currents for MTPC/MTPA, MTPV and MTPF control of anisotropic synchronous machines” by H. Eldeeb et al. and “Optimal setpoint computation for constrained torque control of PMSMs” by T. Englert and K. Graichen.

Modifications of the procedure are also possible for the configuration of FIG. 6. These modifications are analogous to the modifications of the configuration of FIG. 4. In particular, it is possible to carry out the checks in steps S32 and S34 in the reverse order and thus primarily not to determine the current vector i=i7, but the current vector i=i8. Even better is a procedure in which the checks in steps S32 and S34 are combined. If the current vector i=i6 does not pass only one of the two checks in the context of this configuration, the setpoint value determining unit 10 determines the two current vectors i=i7 and i=i8 and checks for both current vectors i=i7 and i=i8 whether they pass the respective other check. The setpoint value determining unit 10 thus checks whether the current vector i=i7 satisfies the condition of inequality 11 and the current vector i=i8 satisfies the condition of inequality 10. If both the current vector i=i7 and the current vector i=i8 pass their respective checks, the setpoint value determining unit 10 selects that one of the two current vectors i=i7 and i=i8 that delivers the higher actual torque M as current vector i. If only one of the two current vectors i=i7 and i=i8 passes its check, while the other of the two current vectors i=i7 and i=i8 fails its check, the setpoint value determining unit 10 selects that one of the two current vectors i=i7 and i=i8 that passes its check as the current vector i. If both current vectors i=i7 and i=i8 do not pass their respective check, the setpoint value determining unit 10 continues with the determination of the current vector i=i9.

The current vectors i1 to i4 of FIG. 4 and i6 to i9 of FIG. 6 can be calculated analytically and therefore very efficiently. Although only a numerical solution is possible for the current vector i5, this solution can also be calculated very quickly, such that the current vector i5 can also be determined in real time. By dividing the two optimization problems O1, O2 into several sub-problems which are solved depending on the situation (compliance with the current and voltage limits, compliance with only one current limit, compliance with only the other current limit, etc.), in particular the real-time capability for the determination of the current vector i is thus achieved, with the current vector i comprising both the field-forming component Id and the torque-forming component Iq of the motor current I as well as the excitation current Ie and thus all relevant currents.

The present invention has many advantages. The method according to the invention can thus be used with any EESM. There is no need for look-up tables for the motor current I and/or the excitation current Ie that have previously been recorded with a high degree of outlay or calculated in advance. No critical simplifications will be made either. Only the motor parameters need to be known. As a result, the method according to the invention can be quickly adapted for a new synchronous motor 1. Compared to methods that only consider a partial operating range of the EESM (in particular the basic speed range) and then use a field-weakening controller to comply with the operating limits, the method according to the invention offers the advantage that all operating ranges are considered in an energy-optimal manner. Calculating the actual optimum operating point results in more torque at the same electrical power or the same torque at a lower electrical power. Taking all current and voltage limits into account also results in improved torque behavior at high rotational speeds. The operating method according to the invention can be set and applied to all externally excited synchronous motors 1. It is also possible to retrofit existing drives. Compared to the solutions from the prior art, it can be expected that the potential savings in electrical energy are at least 3% and may reach up to 10%.

Although the invention has been more specifically illustrated and described in detail by way of the preferred exemplary embodiment, nevertheless the invention is not restricted by the examples disclosed and other variants—in the context of the claims—can be derived therefrom by a person skilled in the art without departing from the scope of protection of the invention.

### LIST OF REFERENCE SIGNS

1 Synchronous motor
2 Stator
3 Motor winding
4, 7 Converter
5 Rotor
6 Excitation winding
8 Converter device
9 Current control device
10 Setpoint value determining unit
11 Computer program
12 Machine code
13 Determination block
a, b, c Phases
i, i1 to i9 Current vectors
I Motor current
Id Field-forming component
Ie Excitation current
Iq Torque-forming component
Lmax Maximum value (motor current)
Iemax Maximum value (excitation current)
Actual torque M
M* Setpoint torque
n Rotational speed
O1, O2 Optimization problems
P Power
Pmax Maximum value (power)
R Resistance (motor winding)
Re Resistance (excitation winding)
S1 to S37 Steps
U Motor voltage
Ue Excitation voltage
Ud, Uq Components of the motor voltage
Umax Maximum value (motor voltage)
ω Electrical angular frequency

1. An operating method for an externally excited synchronous motor comprising an excitation winding and a motor winding,
wherein a setpoint value determining unit receives an instantaneous rotational speed (n) of the synchronous motor and a setpoint torque (M*) to be applied by the synchronous motor,
wherein maximum values (Imax, Iemax, Umax) for an excitation current (Ie) supplied to the excitation winding, a motor current (I) supplied to the motor winding, a motor voltage (U) driving the motor current (I), and a power (P) of the synchronous motor are known to the setpoint value determining unit,
wherein resistance values (Re, R) of the excitation winding and the motor winding are also known to the setpoint value determining unit,
wherein the setpoint value determining unit checks whether a requested power (P) of the synchronous motor-(given by the product of the instantaneous rotational speed (n) and the setpoint torque (M*) to be applied exceeds the maximum value (Pmax) for the power (P),
wherein the setpoint value determining unit, in the case that the requested power (P) does not exceed the maximum value (Pmax) for the power (P), sets a first optimization problem (O1) for a current vector (i) and solves it in real time and/or, in the case that the requested power (P) does exceed the maximum value (Pmax) for the power (P), sets a second optimization problem (O2) for the current vector (i) and solves it in real time,
wherein each current vector (i) has a component for a field-forming component (Id) of the motor current (I), a torque-forming component (Iq) of the motor current (I), and the excitation current (Ie),
wherein the setpoint value determining unit determines the current vector (i) in the context of the solution of the first optimization problem (O1) in such a way that losses (V) occurring in the excitation winding and the motor winding are minimized,
wherein the setpoint value determining unit takes the fact that an actual torque (M) of the synchronous motor resulting from the excitation current (Ie) and the motor current (I) corresponds to the setpoint torque (M*) into account as a supplementary condition in the context of the first optimization problem (O1),
wherein the setpoint value determining unit also takes first general boundary conditions into account in the context of the first optimization problem (O1), in accordance with which the magnitude of the motor current (I) at most reaches the maximum value (Imax) for motor current (I),
the magnitude of the excitation current (Ie) at most reaches the maximum value (Iemax) for the excitation current (Ie), and
the magnitude of the motor voltage (U) at most reaches the maximum value (Umax) for the motor voltage (U),
wherein the setpoint value determining unit determines the current vector (i) in the context of the solution of the second optimization problem (O2) in such a way that the resulting actual torque (M) of the synchronous motor is maximized,
wherein the setpoint value determining unit takes the fact that the magnitude of the motor voltage (U) is equal to the maximum value (Umax) for the motor voltage (U) into account as a supplementary condition in the context of the second optimization problem (O2),
wherein the setpoint value determining unit also takes second general boundary conditions into account in the context of the second optimization problem (O2), in accordance with which the magnitude of the motor current (I) at most reaches the maximum value (Imax) for motor current (I), and
the magnitude of the excitation current (Ie) at most reaches the maximum value (Iemax) for the excitation current (Ie), and
wherein the setpoint value determining unit specifies the components of the current vector (i) determined by solving the first or the second optimization problem (O1, O2) as setpoint values to a current control device for a converter device, so that the current control device actuates the converter device in such a way that the converter device supplies the excitation current (Ie) to the excitation winding and the motor current (I) to the motor winding.

2. The operating method as claimed in claim 1, wherein in the context of the solution of the first optimization problem (O1), the setpoint value determining unit
initially provisionally determines the current vector (i) without taking into account the first general boundary conditions,
then checks whether the provisionally determined current vector (i) satisfies the first general boundary conditions,
uses the provisionally determined current vector (i) as the current vector (i) if the provisionally determined current vector (i) satisfies the first general boundary conditions, and otherwise determines the current vector (i) taking into account at least one of the following first specific boundary conditions, according to which
the magnitude of the motor current (I) is equal to the maximum value (Imax) for the motor current (I),
the magnitude of the excitation current (Ie) is equal to the maximum value (Iemax) for the excitation current (Ie), and
the magnitude of the motor voltage (U) is equal to the maximum value (Umax) for the motor voltage (U), and,
depending on which of the first general boundary conditions are not satisfied, determines which of the first specific boundary conditions it takes into account.

3. The operating method as claimed in claim 2, wherein
in the context of checking whether the provisionally deter-mined current vector (i) satisfies the first general boundary conditions, the setpoint value determining unit
first checks whether the magnitude of the motor current (I) at most reaches the maximum value (Imax) for the motor current (I) and whether the magnitude of the excitation current (Ie) at most reaches the maximum value (Iemax) for the excitation current (Ie), and
only then checks whether the magnitude of the motor volt-age (U) at most reaches the maximum value (Umax) for the motor voltage (U).

4. The operating method as claimed in claim 1, wherein
in the context of the solution of the second optimization problem (O2), the setpoint value determining unit initially provisionally determines the current vector (i) without taking into account the second general boundary conditions,
then checks whether the provisionally determined current vector (i) satisfies the second general boundary conditions,
uses the provisionally determined current vector (i) as the current vector (i) if the provisionally determined current vector (i) satisfies the second general boundary conditions, and otherwise determines the current vector (i) taking into account at least one of the following second specific boundary conditions, according to which
the magnitude of the motor current (I) is equal to the maximum value (Imax) for the motor current (I), and
the magnitude of the excitation current (Ie) is equal to the maximum value (Iemax) for the excitation current (Ie), and
depending on which of the second general boundary conditions are not satisfied, determines which of the second specific boundary conditions it takes into account.

5. The operating method as claimed in claim 4,
in the context of checking whether the provisionally determined current vector (i) satisfies the second general boundary conditions, the setpoint value determining unit
first checks whether the magnitude of the motor current (I) at most reaches the maximum value (Imax) for motor current (I), and
only then checks whether the magnitude of the excitation current (Ie) at most reaches the maximum value (Iemax) for the excitation current (Ie).

6. The operating method as claimed in claim 1, wherein
the setpoint value determining unit only takes the cop-per losses (VK) into account as losses (V).

7. A computer program for a setpoint value determining unit, wherein the computer program comprises machine code which can be executed by the setpoint value determining unit, wherein the execution of the machine code by the setpoint value determining unit has the effect that the setpoint value determining unit carries out an operating method as claimed in claim 1.

8. A setpoint value determining unit for determining setpoint values for an excitation current (Ie) and a motor current (I) of an externally excited synchronous motor, wherein the setpoint value determining device is programmed with a computer program so that it carries out an operating method as claimed in claim 1.

9. A drive,
wherein the drive has an externally excited synchronous motor with an excitation winding and a motor winding
wherein the drive has a converter device which is connected to the excitation winding for supplying an excitation current (Ie) and to the motor winding for supplying a motor current (I),
wherein the drive has a current control device which actuates the converter device,
wherein the drive has a setpoint value determining unit as claimed in claim 8,
wherein the setpoint value determining unit has inputs for receiving an instantaneous rotational speed (n) of the synchronous motor and a setpoint torque (M*) to be applied by the synchronous motor wherein the setpoint value determining unit is connected to the current control device for the specification of a value for a field-forming component (Id) of the motor current (I) and a value for a torque-forming component (Iq) of the motor current (I) and a value for the excitation current (Ie).
